(19) United States
(12) Patent Application Publication
(10) Pub. No.: US 2004/0187315 A1
(43) Pub. Date: Sep. 30, 2004

(54) Tool and method for customizing and fitting automotive windshield moldings

(76) Inventor: Ken Tiu Liu, North Massapequa, NY (US)

Correspondence Address: Niro, Scavone, Haller & Niro, Suite 4600, 181 W. Madison, Chicago, IL, 60602, US

(21) Appl. No.: 10/404,004

(22) Filed: Mar. 31, 2003

(51) Int. Cl. B26B 13/00

(52) U.S. Cl. 30/229

(57) ABSTRACT

The present invention comprises an apparatus and method for customizing a windshield molding, such as an universal automotive windshield molding. The present invention includes a tool having a pair of handles connected to a cutting surface and a reciprocal surface forming opposite sides of mating jaws. The reciprocal surface has an aperture for receiving the cutting surface therein, thus enabling the tool to cut out pieces, most preferably pie or wedge shaped pieces from the interior bend of a windshield molding, thus securing a better mating between the molding and the windshield around any corners.

### I. FIELD OF THE INVENTION

The invention claimed relates to a method and tool for fitting moldings for use with automobile windshields. More specifically, the preferred embodiments of the claimed invention are particularly directed towards a tool for easily and quickly punching automotive windshield moldings so as to reduce stress at the corner of the windshield/molding mating, thus ensuring a better fit for such moldings with a wide variety of automobile windshields.

### II. DESCRIPTION OF THE PRIOR ART

A common problem with existing automobile windows, particularly windshields, is that their replacement often requires the use of a universal molding which may or may not provide a tight, liquid resistant seal between the windshield, the molding, and the automobile body. A tight seal securing the windshield and molding is necessary to prevent seepage of water and other foreign matter into the molding and pinch well. The corrosive effects of such material on moldings and similar materials is well known, and should be avoided.

Prior designs in the art do not account for this problem in a simple and efficient manner. A approach in the art is shown in U.S. Pat. No. 6,3873,696 (Young). This patent purports to describe a multilayer molding including a soft elastomeric material of thermoplastic vulcanate, a harder semi-rigid polyolefin layer at least partially embedded within the body, and a reinforcement layer using a metallic layer such as aluminum. Young, however, involves a potentially costly and overly complex structure for improving the interaction between the molding, the windshield and the body around the windshield corners, nor does Young teach or suggest a solution which can be used retroactively with existing, commercial available moldings.

Another approach can be seen in U.S. Pat. No. 6,279,983 (Biondo et al.). This patent discloses a method for slitting the entire molding along a point of indicia, thus effectively splitting the molding in two. However, Biondo falls to suggest or teach a tool or method for cutting a molding on the interior of a molding, nor does it suggest or teach a tool or method for eliminating puckering or gaps in the molding windshield interface around the corners of the windshield.

### III. DEFINITION OF TERMS

The following terms are used in the claims of the patent as filed and are intended to have their broadest meaning consistent with the requirements of law.

“Interior bend” refers to the portion of the molding closest to the windshield around the interface of the windshield corner and the molding; i.e., the windshield facing surface formed around the corner of a windshield.

“Cutting surface” refers to the surface of the customizing tool which determines the shape of the cuts created on the interior bend of the molding. Most preferably, the cutting surface is “pie shaped” so as to create a number of inverted v-shaped notches on the interior bend, although other shapes may be covered by the tools claimed by the invention (e.g., inverted u-shapes).

“Reciprocal surface” refers to the surface of the customizing tool which receives the cutting surface upon squeezing the handles of the cutting tool. The reciprocal surface preferably has an opening or aperture designed for receiving the cutting surface therethrough.

Where alternative meanings are possible, the broadest meaning is intended. All words used in the claims set forth below are intended to be used in the normal, customary usage of grammar and the English language.

### IV. SUMMARY OF THE INVENTION

The apparatus of the present invention comprises a tool and method for customizing the molding for an automobile windshield. The customizing tool preferably comprises a pair of jaws including a cutting surface and a reciprocal surface for cutting out portions of the inner bend of a automobile windshield molding. Most preferably, the cutting surface cuts out “pie shaped” wedges from the automobile windshield which effectively eliminates excess molding material upon bending around the corner of a windshield. The customizing tool is actuated through the use of a pair of handles which are biased outward through a compressible steel spring (i.e., forcing the jaws open). The user can then squeeze the handles to close the jaws at the desired point of the interior bend of a molding, thus gripping the molding between the cutting surface and the reciprocal surface. The reciprocal surface has a opening which is designed to mate with the cutting surface, thus cutting out portions of the interior bend of the molding, such cut out portions having the same shape as the cutting surface.

The claimed method of this invention is to provide a customized automobile windshield molding which does not pucker or otherwise create gaps around the corners of windshields. Most preferably, this method involves cutting “pie shaped” wedges or similar shapes having increasing width as such wedges extend towards the windshield surface.

Accordingly, one object of the present invention is to provide an automobile windshield molding customizing tool which can be used with stock moldings.

Another object of the present invention is to provide a molding which conforms to the corner of a windshield with minimal gaps and puckering in the molding.

Still another object of the present invention is to provide a customizing tool that allows for quick and easy trimming of excess molding in neat and uniform segments.

Yet another object of the present invention is to provide a tool and method for customizing the tight corner application of universal windshield moldings.

These and other objects, features, and advantages of the present invention will become more apparent in light of the following detailed description of a best mode embodiment thereof, and as illustrated in the accompanying drawings.

### V. BRIEF DESCRIPTION OF THE DRAWINGS

FIG. 1 shows a side view of a preferred embodiment in accordance with the present invention.

FIG. 2 shows a partial bottom view showing the interaction of the cutting surface and the reciprocal surface in accordance with the present invention.

FIG. 3 shows a front view of a molding customized in accord with the customizing tool of the present invention.

FIG. 4 shows a front view of a molding customized in accord with the present invention placed in situ around the corner of a windshield.

### VI. DETAILED DESCRIPTION OF THE INVENTION

Set forth below is a description of what is currently believed to be the preferred embodiment or best examples of the invention claimed. Future and present alternatives and modifications to this preferred embodiment are contemplated. Any alternatives or modifications which make insubstantial changes in function, in purpose, in structure or in result are intended to be covered by the claims of this patent.

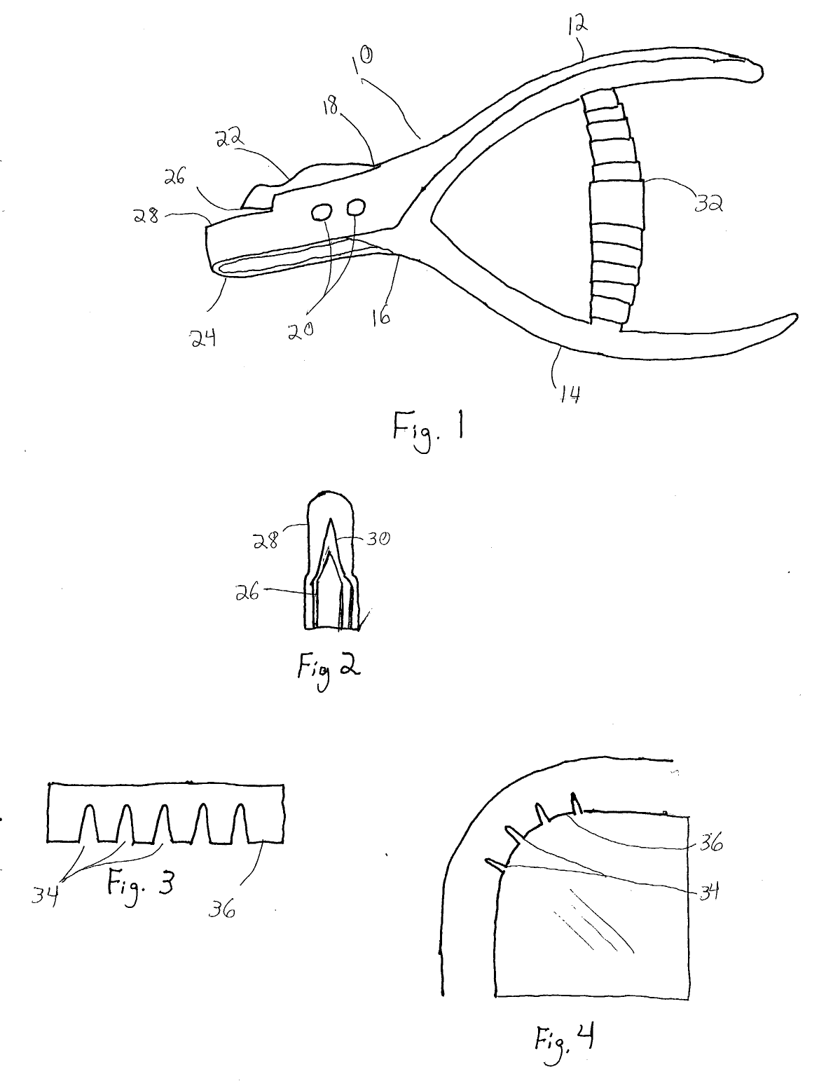

FIGS. 1 and 2 show a first preferred embodiment of the customizing tool of 10 the present invention, comprising the handles 12, 14, having forked interlacing portions 16, 18, which are connected to one another by means of one or more pivot pins or hinges 20, and terminate in upper and lower jaws 22, 24. The upper jaw 24 terminates in a cutting surface 26. Most preferably the cutting surface 26, when viewed from the bottom (such as in FIG. 2) has a pie or wedge shape so as to permit the broadest cut of the windshield molding at the points of the molding closest to the edge of the interior bend (as shown in FIG. 3).

The cutting surface 26 engages in a mating relationship with the reciprocal surface 28. The reciprocal surface 28 is generally a flat surface providing the terminus of the lower jaw 24. The reciprocal surface preferably has an aperture 30, which is generally the same shape as the cutting surface 26, thus facilitating the cutting of pie or wedge shaped pieces out of the windshield molding.

The jaws 22, 24, are preferably biased in an “open” position through the use of a compressible steel spring or coil 32. The coil 32 is attached to the interior of the handles 12, 14 through a mechanical or friction fit around posts (not shown) or through similar adhesive or mechanical attachment as would be understood by those of ordinary skill in the art. Thus, the user of the customizing tool 10 would position the tool so as to place the portion of the molding desired to be cut between the upper and lower jaws. The user would then squeeze the handles 12, 14, thus causing the jaws 22, 24 to close and cutting a shape (again, most preferably a pie or wedge shape) out of the molding.

The method of customizing an automotive windshield using this customizing tool would take place as follows. First, the installer of the windshield molding would determine the portions of the molding which would extend around the corners of the windshield. Then, as shown in FIGS. 3 and 4, using the customizing tool 10, the installer could make a plurality of regularly spaced wedge shape cuts 34 around the interior bend 36 (i.e., the edge of the molding closest to the windshield corner). Then, once the desired cuts were made, the installer could complete the installation of the windshield molding by making sure completing the fit between the molding, the auto body, and the windshield.

The advantages of this process and the use of the customizing tool, in addition to those summarized above, is the uniform yet quick cuts created by the use of the tool which would not be possible through more generic tools: The present invention improves the fit of universal moldings, thus preventing seepage and a non-liquid tight seal, while at the same time preventing gaps or puckering around the corners of the windshield.

The above description is not intended to limit the meaning of the words used in the following claims that define the invention. Rather, it is contemplated that future modifications in structure, function or result will exist that are not substantial changes and that all such insubstantial changes in what is claimed are intended to be covered by the claims. For instance, the “upper” and “lower” jaws are merely for frame of reference—clearly the present invention would include use of the customizing tool with the cutting surface on the bottom jaw. Further, the steps for the method of the present invention are not intended to dictate a specific order of steps. The method claimed in the present invention is intended to cover both the in situ cutting of wedges from the molding as well as cutting such material prior to mating the molding with the windshield. Likewise, it will be appreciated by those skilled in the art that various changes, additions, omissions, and modifications can be made to the illustrated embodiments without departing from the spirit of the present invention. All such modifications and changes are intended to be covered by the following claims.

I claim:

1. A tool for customizing an automobile windshield molding comprising:
a) a pair of handles, said handles being pivotably connected to one another;
b) a cutting surface connected to one of said pair of handles; and
c) a reciprocal surface connected to the other of said pair of handles, said reciprocal surface defining an aperture for said cutting surface, said reciprocal surface and said cutting surface creating a mating engagement so as to cut a portion of an automobile windshield molding so as to improve the fit of said molding around the corner of a windshield.

2. A method for customizing an automobile windshield molding comprising:
a) making a plurality of uniform shaped cuts in a portion of an automotive windshield molding; and
b) mating said portion of said automobile windshield molding having said cuts with the corner of an automotive windshield.
